(19) United States
(12) Patent Application Publication
(10) Pub. No.: US 2025/0182315 A1
(43) Pub. Date: Jun. 5, 2025

(54) MODEL GENERATION APPARATUS, MODEL GENERATION METHOD, AND PROGRAM

(71) Applicant: NEC Corporation, Minato-ku, Tokyo (JP)

(72) Inventors: Tomokazu KANEKO, Tokyo (JP); Some SHIRAISHI, Tokyo (JP); Takami SATO, Tokyo (JP)

(73) Assignee: NEC Corporation, Minato-ku, Tokyo (JP)

(21) Appl. No.: 18/840,209

(22) PCT Filed: Jun. 2, 2022
(86) PCT No.: PCT/JP2022/022528

§ 371 Date: Aug. 21, 2024

(51) Int. Cl. G06T 7/70; G06V 10/25; G06V 10/44

(52) U.S. Cl. CPC G06T 7/70; G06V 10/25; G06V 10/44; G06T 2207/20081; G06V 2201/07

(57) ABSTRACT

A model generation apparatus of the present disclosure includes: a detecting means that detects, using an object detection model, a first position that is a position of an object in a first image and a second position that is a position of an object in a second image with a different angle of view from the first image; a generating means that generates a corresponding position that is a corresponding position within the second image to the first position from the first position based on a difference in angle of view between the first image and the second image; and a training means that trains the object detection model based on the second position and the corresponding position.

### TECHNICAL FIELD

The present disclosure relates to a model generation apparatus that generates a model for detecting an object included in an image.

### BACKGROUND ART

A technique for detecting an object from a captured image of objects is known. For example, as described in Patent Literature 1, a system is proposed that captures an image of a product shelf in a store, identifies the positions of products, and performs planogram analysis. In such a system, an object detection model to identify the positions of products is trained in advance using a large number of captured images of product shelves. During operation, the positions of products included in an image of a product shelf captured in each store are identified using the trained object detection model.

Here, Patent Literature 1 raises an issue that a captured image of a shelf on which products are displayed is affected by an environment such as the imaging angle of view at the time of imaging and decrease of recognition precision thereby occurs such as misrecognition or omission of recognition of a product. To address this issue, Patent Literature 1 describes a method of detecting a region in which there is a high possibility of occurrence of omission of recognition using information about fixtures.

### CITATION LIST

### Patent Literature

Patent literature 1: Japanese Unexamined Patent Application Publication No. 2020-061158

### SUMMARY OF INVENTION

### Technical Problem

However, the method described in Patent Literature 1 mentioned above requires that information about fixtures are stored in advance and, in a case where such information is not available, omission of recognition of a product cannot be detected. Consequently, there still remains the problem that the precision of detection of an object in an image decreases due to the imaging angle of view of the image.

An object of the present disclosure is to solve the abovementioned issue that the precision of detection of an object in an image decreases due to the imaging angle of view of the image.

### Solution to Problem

A model generation apparatus as an aspect of the present disclosure includes: a detecting means that detects, using an object detection model, a first position that is a position of an object in a first image and a second position that is a position of an object in a second image with a different angle of view from the first image; a generating means that generates a corresponding position that is a corresponding position within the second image to the first position from the first position based on a difference in angle of view between the first image and the second image; and a training means that trains the object detection model based on the second position and the corresponding position.

Further, a model generation method as an aspect of the present disclosure includes: detecting, using an object detection model, a first position that is a position of an object in a first image and a second position that is a position of an object in a second image with a different angle of view from the first image; generating a corresponding position that is a corresponding position within the second image to the first position from the first position based on a difference in angle of view between the first image and the second image; and training the object detection model based on the second position and the corresponding position.

Further, a program as an aspect of the present disclosure includes instructions for causing a computer to execute processes to: detect, using an object detection model, a first position that is a position of an object in a first image and a second position that is a position of an object in a second image with a different angle of view from the first image; generate a corresponding position that is a corresponding position within the second image to the first position from the first position based on a difference in angle of view between the first image and the second image; and train the object detection model based on the second position and the corresponding position.

### Advantageous Effects of Invention

Configured as described above, the present disclosure can suppress decrease of precision of detection of an object in an image due to the imaging angle of view of the image.

### BRIEF DESCRIPTION OF DRAWINGS

FIG. 1 is a view showing the overall configuration of an object detection system in a first example embodiment of the present disclosure.

FIG. 2 is a view showing an example of a store environment in which an object detection apparatus disclosed in FIG. 1 is used.

FIG. 3 is a block diagram showing the hardware configuration of the object detection apparatus disclosed in FIG. 1.

FIG. 4 is a block diagram showing the configuration of the object detection apparatus disclosed in FIG. 1.

FIG. 5 is a view showing an aspect of image processing by the object detection apparatus disclosed in FIG. 1.

FIG. 6 is a view showing an aspect of image processing by the object detection apparatus disclosed in FIG. 1.

FIG. 7 is a flowchart showing the operation at the time of training of an object detection model by the object detection apparatus disclosed in FIG. 1.

FIG. 8 is a block diagram showing the configuration of a model generation apparatus in a second example embodiment of the present disclosure.

### DESCRIPTION OF EXAMPLE EMBODIMENTS

Example embodiments of the present disclosure will be described below with reference to the drawings.

### First Example Embodiment

### Overall Configuration

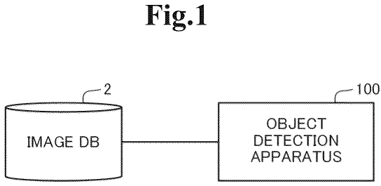

FIG. 1 shows the overall configuration of an object detection system according to a first example embodiment. As shown in FIG. 1, the object detection system includes an object detection apparatus 100 and an image database (“database” will be referred to as “DB” hereinafter) 2. The object detection apparatus 100 acquires image data from the image DB 2 and performs object detection. Along with this, the object detection apparatus 100 of the present disclosure also has a function as a model generation apparatus that generates by training an object detection model used for performing object detection. Then, at the time of training the object detection model by the object detection apparatus 100, a training data set is stored in the image DB 2. On the other hand, in the case of applying and using the object detection apparatus 100 in an actual store or the like, that is, at the time of inference for detecting an object from an image, an image captured in the store is stored in the image DB 2.

### Example of Store Environment

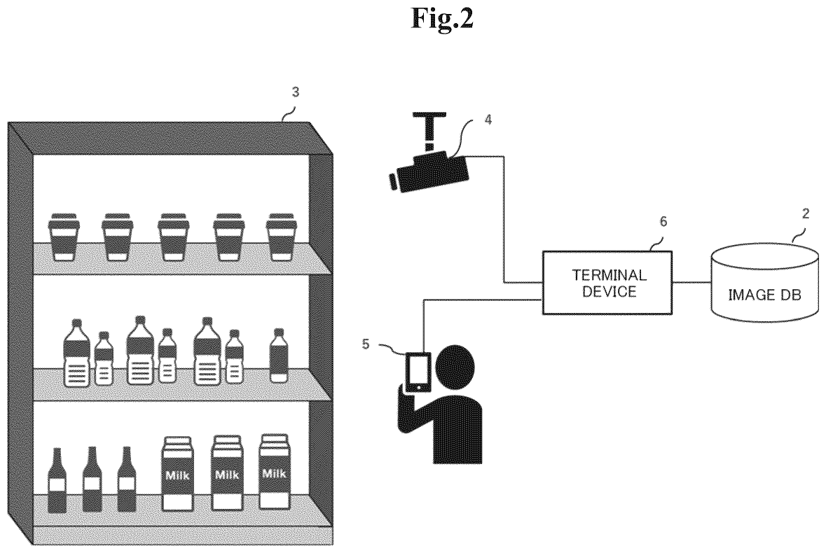

FIG. 2 shows an example of a store environment in which the object detection apparatus 100 is used. A store shelf 3 is installed in the store, and various products are displayed on the store shelf 3. A security camera 4 is installed in the store and captures an image of the store shelf 3. The image captured by the security camera 4 is sent to a terminal device 6 and stored in the image DB2 connected to the terminal device 6. In front of the store shelf 3, a store clerk captures a front image of the store shelf 3 with a mobile device camera 5. The image captured with the mobile device camera 5 is sent to the terminal device 6 and recorded in the image DB 2. The object detection apparatus 100 is realized by, for example, the terminal device 6 or another terminal device.

### Hardware Configuration

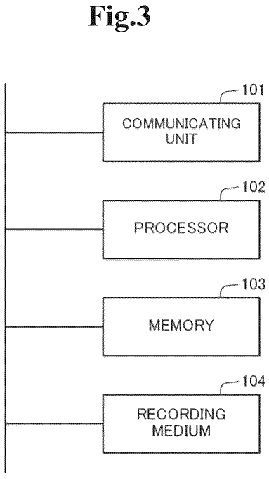

FIG. 3 is a block diagram showing the hardware configuration of the object detection apparatus 100. As shown in the figure, the object detection apparatus 100 includes a communicating unit 101, a processor 102, a memory 103, and a recording medium 104.

The communicating unit 101 communicates with the image DB 3 by wire or wirelessly and acquires a prepared training data set, an image captured with the camera 4 of the store, and the like. The processor 102 is a computer such as a CPU (Central Processing Unit) and executes a prepared program to control the entire object detection apparatus 100. In addition, the processor 102 may be a GPU (Graphics Processing Unit), a FPGA (Field-Programmable Gate Array), a DSP (Digital Signal Processor), a MPU (Micro Processing Unit), a FPU (Floating point number Processing Unit), a PPU (Physics Processing Unit), a TPU (Tensor Processing Unit), a quantum processor, a microcontroller, or a communication thereof. Specifically, the processor 102 executes a pretraining process and an additional training process, which will be described later.

The memory 103 includes a ROM (Read Only Memory), a RAM (Random Access Memory), and the like. The memory 103 is also used as a working memory during execution of various processes by the processor 102.

The recording medium 104 is a nonvolatile and non-transitory recording medium such as a disk-shaped recording medium or a semiconductor memory, and is configured to be detachable from the object detection apparatus 100. On the recording medium 104, various programs executed by the processor 102 are recorded. When the object detection apparatus 100 executes various processes, the program recorded on the recording medium 104 is loaded to the memory 103 and executed by the processor 102.

### Configuration of Object Detection Apparatus

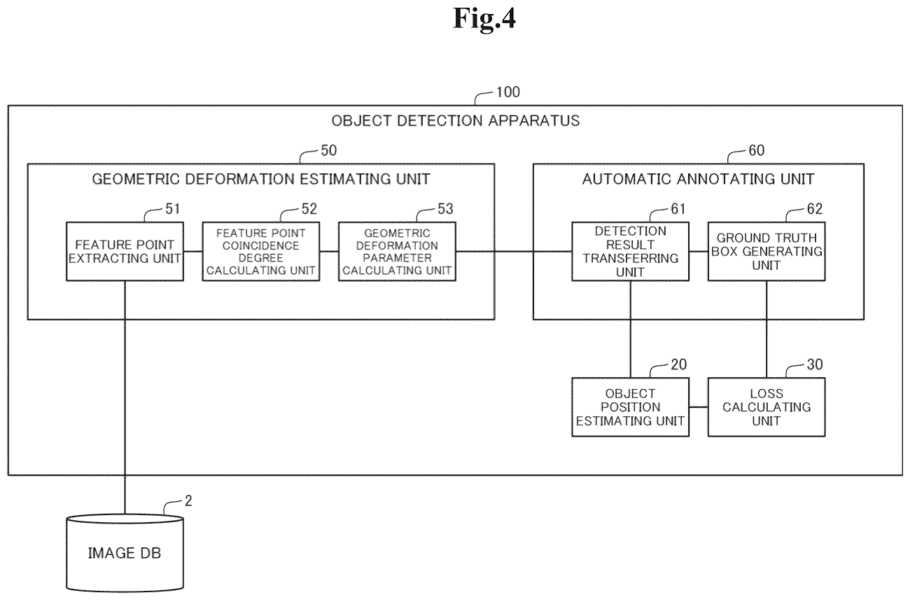

Next, the configuration of the object detection apparatus 100 will be described. As shown in FIG. 4, the abovementioned object detection apparatus 100 to which the image DB 2 is connected includes an object position estimating unit 20, a loss calculating unit 30, a geometric deformation estimating unit 50, and an automatic annotating unit 60. The object position estimating unit 20, the loss calculating unit 30, the geometric deformation estimating unit 50, and the automatic annotating unit 60 can be realized by the processor 102 executing a program stored in the memory 103 or the recording medium 104. At this time, the geometric deformation estimating unit 50 further includes a feature point extracting unit 51, a feature point coincidence degree calculating unit 52, and a geometric deformation parameter calculating unit 53. Moreover, the automatic annotating unit 60 further includes a detection result transferring unit 61 and a ground truth box generating unit 62. Below, the respective components will be described in detail.

First, a function of pretraining by the object position estimating unit 20 and the loss calculating unit 30 will be described. Pretraining is a process of first generating a basic object detection model. For this, first, the image DB 2 stores a pretraining image data set used in pretraining. Specifically, the pretraining image data set includes a pretraining image of a product shelf having been prepared and ground truth data of a product position. For example, the pretraining image is an image of a product shelf captured from the front, and the ground truth data is shown by the coordinates of the vertices of a box indicating the position of an object included in each pretraining image.

The object position estimating unit 20 detects an object included in an input image using the object detection model. Specifically, at the time of pretraining, the object position estimating unit 20 estimates, using the object detection model, box coordinates indicating the position of an object included in a pretraining image input from the image DB 2. The object detection model is configured with a neural network using a CNN (Convolutional Neural Network), for example. The object position estimating unit 20 outputs, to the loss calculating unit 30, the box coordinates estimated from the pretraining image input from the image DB 2 and the ground truth data of the position of the object included in the input pretraining image, associated with the pretraining image.

The loss calculating unit 30 calculates a loss using the input ground truth data of the object position and the result of estimation by the object position estimating unit 20. Specifically, the loss calculating unit 30 calculates, as a loss, an error between the box coordinates of the position of the object included in the input ground truth data and the box coordinates as the result of estimation of the position of the object in the pretraining image by the object position estimating unit 20. Then, the loss calculating unit 30 updates the parameter of the object detection model of the object position estimating unit 20 so as to reduce the calculated loss. Thus, the parameter of the object detection model is updated until the value of the loss converges to a predetermined value or less, and pretraining of the object detection model ends at the moment of convergence of the loss. The object detection model at the moment of end of training is obtained as a pretrained object detection model.

Since the object detection model generated through pretraining in the abovementioned manner is trained with a pretraining image of a product shelf captured from the front mainly, the precision of object detection for an image of the product shelf captured from the front is high, whereas the precision of object detection for an image with a different angle of view from the front image of the product shelf, for example, an image captured by the security camera 4 of the store as shown in FIG. 2 is expected to be low. Therefore, the object detection apparatus 100 of the present disclosure further has a function of additionally training the object detection model so as to increase the precision of object detection from an image with a different angle of view from a frontal image, such as an image captured by the security camera 4. In addition, the object detection model generated through pretraining mentioned above is not necessarily limited to being generated by the object detection apparatus 100, and one generated by another apparatus or one prepared may be used. A configuration for performing additional training by the object detection apparatus 100 will be described below.

The image DB 2 includes, for additional training, a pair including two images (an image pair) of the same product shelf 3, namely, the same target object, captured by the security camera 4 and the mobile device camera 5 at the same time of day in a range that there is no movement of products. Here, the mobile device camera 5 captures an image of the product shelf 3 from the front, and the image will be referred to as a “front image” (first image). However, the front image is not limited to being obtained by capturing the product shelf 3 strictly from the front, and may be obtained by capturing from almost the front. Moreover, the security camera 4 is installed, for example, on the ceiling or wall of the store, and the angle of view of an image captured by the security camera 4 is different from that of the front image. The image captured by the security camera 4 will be referred to as a “security camera image” (second image). In addition, the front image described in this example embodiment is not necessarily limited to an image of the product shelf 3 captured from the front by the mobile device camera 5, and may be an image captured from any direction by any imaging device. Moreover, the security camera image is not necessarily limited to an image captured by the security camera 4, and may be an image captured from any direction by any imaging device. However, the first image corresponding to the front image and the second image corresponding to the security camera image are images with mutually different angles of view.

The geometric deformation estimating unit 50 (estimating means) uses the abovementioned image pair for additional training included in the image DB2, namely, a front image and a security camera image paired with each other and thereby estimates a geometric deformation parameter between the two images. In particular, in this example embodiment, the geometric deformation estimating unit 50 estimates an affine transformation parameter for matching the angle of view of the mobile device camera 5 with the angle of view of the security camera 4.

Specifically, the feature point extracting unit 51 extracts feature points on each of the input two images, the security camera image and the front image. The extracted feature points are input to the feature point coincidence degree calculating unit 52 with their coordinate values and feature values held as vectors.

The feature point coincidence degree calculating unit 52 calculates the degree of similarity between the feature points of the two images extracted by the feature point extracting unit 51, and outputs a pair of feature points with high degree of similarity. For example, for each of the feature points of the front image, the cosine similarities between the feature point and all the feature points of the security camera image are calculated, and a point with the highest degree of similarity among points with higher degrees of similarity than a determined value is adopted as a point to be paired with. That is to say, the feature point coincidence degree calculating unit 52 extracts the pair of a feature point in the front image (first feature point) and a feature point in the security camera image (second feature point) corresponding to the first feature point. Then, the feature point coincidence degree calculating unit 52 outputs the respective coordinates values of the points of the adopted pair to the geometric deformation parameter calculating unit 53.

The geometric deformation parameter calculating unit 53 uses the coordinates of the pair of coincident feature points between the two images adopted by the feature point coincidence degree calculating unit 52 and thereby calculates an affine transformation parameter for matching the angle of view of the front image with the angle of view of the security camera image. Specifically, for each feature point pair, affine transformation is performed on the coordinates of the feature point of the front image, an error between the coordinates and the coordinates of the feature point of the security camera image is calculated, and an affine transformation parameter is determined so that the sum of the errors of the respective feature point pairs becomes smaller. The affine transformation parameter thus obtained is output as a geometric deformation parameter to the detection result transferring unit 61.

The abovementioned geometric deformation parameter calculation method is merely an example, and is not limited to this method as long as it is a method for associating the identical points between two images paired with each other. For example, in a case where the installation positions and angles of view of the two cameras are given as meta-information, transformation of the angle of view between the cameras can be analytically calculated to estimate the identical points.

The object position estimating unit 20 (detecting means) estimates the position of an object included in an input image using the pretrained object detection model. That is to say, in additional training, the object position estimating unit 20 inputs a front image and a security camera image paired with each other, and estimates the position of an object included in each of the images. At this time, for the front image, it is possible to estimate the position of the object with high precision because the pretrained object detection model generated through learning images with similar angles of view in pretraining. On the other hand, for the security camera image, the precision of detection of the object by the pretrained object detection model is low because images with similar angles of view are not used in pretraining. The object position estimating unit 20 outputs front image coordinates (first position) representing the position of the product in the front image as the result of estimation of the object position for the front image, to the automatic annotating unit 60, and outputs security camera image coordinates (second position) representing the position of the product in the security camera image as the result of estimation for the security camera image, to the loss calculating unit 30.

The automatic annotating unit 60 (generating means) uses the geometric deformation parameter output by the geometric deformation estimating unit 50 and the box coordinates indicating the position of the product in the front image output by the object position estimating unit 20, and thereby transfers the front image coordinates as the result of estimation by the object position estimating unit 20 for the front image to coordinates on the security camera image. Specifically, the box coordinates that are the front image coordinates representing the position of the object estimated by the object position estimating unit 20 are transformed in accordance with the geometric deformation parameter estimated by the geometric deformation estimating unit 50, and transformation coordinates (corresponding position) corresponding to the position of the object included by the security camera image are found.

Specifically, the detection result transferring unit 61 transforms the position of the object included in the front image estimated by the object position estimating unit 20 using the affine transformation parameter calculated by the geometric deformation parameter calculating unit 53, and calculates the corresponding position of the object on the security camera image. In this example embodiment, the detection result transferring unit 61 transforms the coordinates of the four points of a box that are the front image coordinates indicating the position of the object included in the front image estimated by the object position estimating unit 20, using the affine transformation parameter calculated by the geometric deformation parameter calculating unit 53, and outputs the coordinate values of the four points that are the transformation coordinates obtained by the transformation to the ground truth box generating unit 62.

The ground truth box generating unit 62 further transforms the transformation coordinates of the position of the object on the security camera image calculated by the detection result transferring unit 61 to box coordinates for training the object detection model. For example, the ground truth box generating unit 62 calculates the smallest box surrounding the four points that are the transformation coordinates representing the object position as a result of calculation by the detection result transferring unit 61, and outputs the coordinates of four points to be the vertices of the smallest box to the loss calculating unit 30 as a ground truth box (position information).

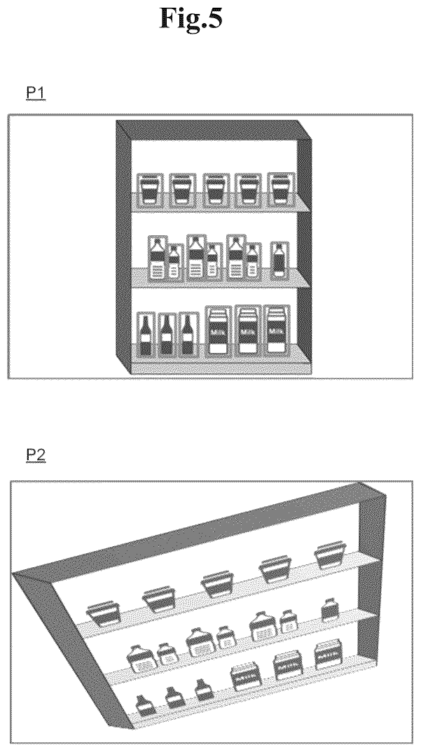

FIG. 5 shows an example of a front image P1 and a security camera image P2 paired with each other. The front image P1 and the security camera image P2 paired with each other are images of the same product shelf captured at the same time of day in a range that objects do not move, so that the same products are displayed in the same arrangement on the product shelves in both the images. A box surrounding a product shown in the front image P1 is an example of front image coordinates indicating the position of the product in the front image detected from the front image P1, which is the result of output by the object position estimating unit 20. The security camera image P2 is an image of the product shelf captured at a different angle of view from the front image. Security camera image coordinates indicating the position of the product in the security camera image detected from the security camera image P2, which is the result of output by the object position estimating unit 20, are not illustrated in the security camera image P2.

Then, using the front image and the security camera image paired with each other mentioned above, the geometric deformation estimating unit 50 mentioned above estimates a geometric deformation parameter so as to match the angles of view of both the images. Moreover, the automatic annotating unit 60 uses the geometric deformation parameter as the result of estimation by the geometric deformation estimating unit 50 and thereby transforms the front image coordinates representing the position of the product in the front image as the result of estimation by the object position estimating unit 20 shown in the front image P1, into coordinates on the security camera image P2.

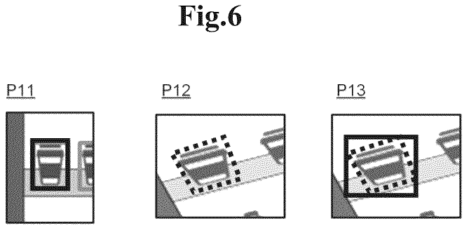

FIG. 6 shows an aspect of transformation of box coordinates representing the object position by the automatic annotating unit 60 described above. Reference symbol P11 in FIG. 6 denotes one of the products shown in the front image P1 and a product position box obtained by estimating a position thereof with the object position estimating unit 20. Reference symbol P12 in FIG. 6 denotes, by dotted line, a box obtained when the product position box in the front image denoted by reference symbol P11 is deformed by the detection result transferring unit 61 with a geometric deformation parameter and transferred onto the security camera image P2. At this time, the dotted-line box denoted by reference symbol P12 is not suitable as an input to the loss calculating unit 30 to be described later, so that the abovementioned ground truth box generating unit 62 transforms into the smallest box including the dotted-line box, namely, a solid-line box as denoted by reference symbol P13. The coordinates of the solid-line box denoted by reference symbol P13 are output as a ground truth box (ground truth data) to the loss calculating unit 30.

The loss calculating unit 30 (training means) calculates a loss using the security camera image coordinates (second position) indicating the position of the product in the security camera image, which is output by the object position estimating unit 20, and the ground truth box (position information based on the corresponding position), which is output by the automatic annotating unit 60, updates the parameter of the object detection model of the object position estimating unit 20 by the same method as in pretraining, and executes training. Specifically, an error between the box coordinates that are the security camera image coordinates as the result of estimation by the object detection model for the security camera image and ground truth box coordinates of the object position calculated by the automatic annotating unit 60 is calculated and set as a loss. Then, the loss calculating unit 30 updates the parameter of the object detection model so as to reduce the loss. The parameter of the object detection model is updated until the value of the loss converges to a predetermined value or less, and pretraining of the object detection model ends at the moment of convergence of the value of the loss. The object detection model at the moment of end of training is obtained as a trained object detection model.

The trained object detection model obtained in the above manner is used for detection of an object from an image to be an inference target later. Specifically, the object position estimating unit 20 inputs a security camera image to be an inference target, estimates box coordinates indicating the position of an object included in the input image using the trained object detection model, and outputs the result.

In the above configuration, the object position estimating unit 20 is merely an example of the detecting means, the geometric deformation estimating unit 50 and the automatic annotating unit 60 are merely an example of the generating means, and the loss calculating unit 30 is merely an example of the training means.

### Operation of Object Detection Apparatus

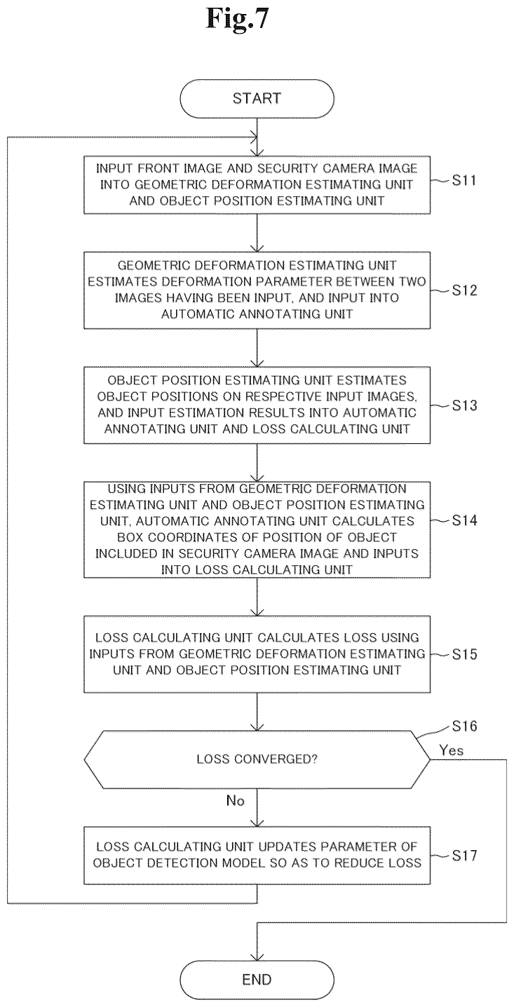

Next, the operation of the object detection apparatus 100 will be described. FIG. 7 is a flowchart of an object detection model training process, and particularly shows the abovementioned additional training operation. For this, the object detection apparatus 100 has performed the abovementioned pretraining in advance and has generated a basic object detection model. Moreover, the image DB2 stores an image pair including a front image and a security camera image obtained by capturing the same product shelf at the same time of day in a range that objects do not move.

First, the object detection apparatus 100 inputs an image pair including a front image and a security camera image into the geometric deformation estimating unit 50 and the object position estimating unit 20 from the image DB 2 (step S11). The geometric deformation estimating unit 50 estimates a geometric deformation parameter between the two images having been input and inputs the geometric deformation parameter into the automatic annotating unit 60 (step S12). The object position estimating unit 20 estimates box coordinates indicating the positions of the respective objects included in the two images, and inputs the results of estimation into the automatic annotating unit 60 and the loss calculating unit 30 (step S13). Specifically, the object position estimating unit 20 inputs the result of estimation for the front image, namely, ground truth image coordinates into the automatic annotating unit 60, and inputs the result of estimation for the security camera image, namely, security camera image coordinates into the loss calculating unit 30. In addition, the object position estimation process at step S13 may be performed in prior to the geometric deformation parameter estimation process at step S12.

Subsequently, using the inputs from the geometric deformation estimating unit 50 and the object position estimating unit 20, the automatic annotating unit 60 calculates the box coordinates of the position of the object included in the security camera image, and inputs the box coordinates into the loss calculating unit 30 (step S14). Specifically, the automatic annotating unit 60 transforms the box coordinates, which are the front image coordinates indicating the position of the object estimated from the front image by the object position estimating unit 20, in accordance with the geometric deformation parameter estimated by the geometric deformation estimating unit 50, finds transformation coordinates corresponding to the position on the security camera image, and inputs the transformation coordinates into the loss calculating unit 30. In addition, the process of generating the transformation coordinates from the front image coordinates at step S14 may be performed in prior to the process of estimating the object position from the security camera image at step S13. That is to say, the process of estimating the object position from the security camera image at step S13 may be performed after step 14.

The loss calculating unit 30 calculates a loss using the box coordinates input from the automatic annotating unit 60 and the object position estimating unit 20 (step S15). Specifically, the loss calculating unit 30 calculates a loss using the security camera image coordinates output by the object position estimating unit 20, indicating the position of the product in the security camera image, and the ground truth box coordinates output by the automatic annotating unit 60. Then, the loss calculating unit 30 determines whether or not the loss has converged to be a predetermined value or less (step S16). In a case where the loss has not converged (step S16: No), the loss calculating unit 30 updates the parameter of the object detection model configuring the object position estimating unit 20 so as to reduce the loss (step S17). Then, the process returns to step S11. On the other hand, in a case where the loss has converged (step S16: Yes), the process ends.

After that, the object detection apparatus 100 can input a security camera image to be an inference target, estimate coordinates indicating the position of an object included in the input image using the trained object detection model, and output the result.

Thus, by training an object detection model using paired images including a front image and a security camera image with different angles of view, the object detection model generation apparatus in the first example embodiment can perform detection of an object in an image with precision on any new image such as the security camera image with a different angle of view from the front image. At this time, since the object positions of the front image and the security camera image are automatically annotated, it is possible to generate an object detection model that can deal with an image with a new angle of view while keeping the cost for manually annotating low.

In the above example embodiment, a case where an object to detect is a product displayed on a product shelf has been illustrated, but the purpose of the preset disclosure is not limited to product detection. For example, it can be applied to a field where training images captured from a plurality of angles of view during a period in a range that the position of an object does not change can be obtained, such as a security camera for persons, detection of abandoned objects, or monitoring of goods.

### Second Example Embodiment

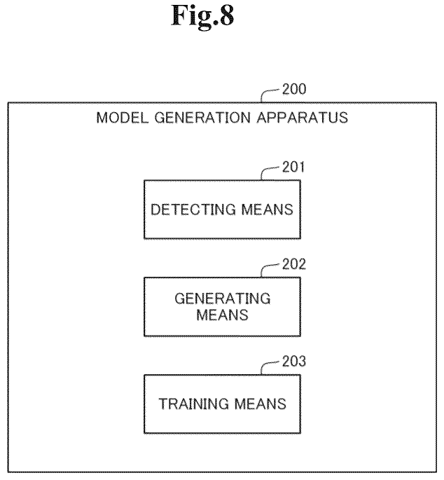

Next, a second example embodiment of the present disclosure will be described with reference to FIG. 8. FIG. 8 is a block diagram showing the configuration of a model generation apparatus in the second example embodiment. In this example embodiment, the overview of the configuration of the object detection apparatus described in the above example embodiment is shown.

A model generation apparatus 200 in this example embodiment is configured with a general information processing apparatus and, as an example, includes the same hardware configuration as the object detection apparatus described in the first example embodiment. That is to say, the model generation apparatus includes components such as a communicating unit, a processor, a memory, and a recording medium.

Then, the model generation apparatus 200 can construct and include a detecting means 201, a generating means 202, and a training means 203 shown in FIG. 8 by acquisition and execution of a program stored in the memory or the recording medium by the processor. In addition, the program may be provided to the processor via a communication network, or may be stored in the recording medium in advance and retrieved by a drive device and provided to the processor. However, the detecting means 201, the generating means 202, and the training means 203 mentioned above may be constructed by a dedicated electronic circuit for realizing these means.

The detecting means 201 detects, using an object detection model, a first position that is the position of an object in a first image and a second position that is the position of an object in a second image with a different angle of view from the first image. At this time, the first image and the second image are images obtained by capturing the same target where the object is located, and the angles of view thereof are different from each other. For example, the images are those obtained by capturing a product shelf where objects are displayed and, as an example, the first image is an image of the product shelf captured from the front, and the second image is a security camera image of the product shelf captured with a security camera installed on the ceiling or the like. Then, the detecting means 201 detects the positions (first position and second position) of the product displayed on the product shelf from the front image and the security camera image. Since the object detection model at this moment has been trained using images captured at the angle of view of the first image mainly, the precision of object detection from the first image is high and the precision of object detection from the second image is low.

The generating means 202 generates a corresponding position that is a position within the second image corresponding to the first position from the first position based on a difference in angle of view between the first image and the second image. For example, the generating means 202 estimates a difference in angle of view between the first image and the second image, and generates a deformation parameter for deforming the first image to the second image. Then, the generating means 202 generates a corresponding position obtained by deforming the position of the object in the first image, for example, the position (first position) of the object in the front image by using the generated deformation parameter. Consequently, a corresponding position on the second image with a different angle of view is generated from the first position detected from the first image with precision.

The training means 203 trains the object detection model based on the second position and the corresponding position. For example, the training means 203 trains by updating the parameter of the object detection model with the corresponding position as ground truth data for the second position. Consequently, training is performed so that the position of an object detected using the object detection model from the second image, for example, from a security camera image gets closer to the corresponding position.

Configured as described above, the present disclosure can detect the position of an object with precision from the second image with a different angle of view from the first image using the generated object detection model.

Although the present disclosure has been described above with reference to the above example embodiments and so forth, the present disclosure is not limited to the abovementioned example embodiments. The configurations and details of the present disclosure can be changed in various manners that can be understood by one skilled in the art within the scope of the present invention. Moreover, at least one or more of the functions of the detecting means, the generating means, and the training means described above may be executed by an information processing apparatus installed and connected in any place on the network, that is, may be executed on the so-called cloud computing.

### SUPPLEMENTARY NOTES

The whole or part of the example embodiments disclosed above can be described as the following supplementary notes. Below, the overview of the configurations of a model generation apparatus, a model generation method, and a program according to the present invention will be described. However, the present invention is not limited to the following configurations.

### Supplementary Note 1

A model generation apparatus comprising:
a detecting means that detects, using an object detection model, a first position that is a position of an object in a first image and a second position that is a position of an object in a second image with a different angle of view from the first image;
a generating means that generates a corresponding position that is a corresponding position within the second image to the first position from the first position based on a difference in angle of view between the first image and the second image; and
a training means that trains the object detection model based on the second position and the corresponding position.

### Supplementary Note 2

The model generation apparatus according to Supplementary Note 1, wherein
the generating means calculates a deformation parameter for deforming the first image to the second image based on the first image and the second image, and generates the corresponding position from the first position using the deformation parameter.

### Supplementary Note 3

The model generation apparatus according to Supplementary Note 2, wherein
the generating means extracts a first feature point within the first image and a second feature point within the second image corresponding to the first feature point, and calculates the deformation parameter based on the first feature point and the second feature point.

### Supplementary Note 4

The model generation apparatus according to Supplementary Note 2, wherein
the generating means deforms a box region corresponding to the first position using the deformation parameter, and generates the corresponding position.

### Supplementary Note 5

The model generation apparatus according to Supplementary Note 1, wherein
the training means trains the object detection model so as to decrease an error between the second position that is the position of the object within the second image detected using the object detection model and position information based on the corresponding position.

### Supplementary Note 6

The model generation apparatus according to Supplementary Note 5, wherein
the training means trains the object detection model so as to decrease an error between the second position that is the position of the object within the second image detected using the object detection model and position information composed of a box including a region of the corresponding position.

### Supplementary Note 7

A model generation method comprising:
detecting, using an object detection model, a first position that is a position of an object in a first image and a second position that is a position of an object in a second image with a different angle of view from the first image;
generating a corresponding position that is a corresponding position within the second image to the first position from the first position based on a difference in angle of view between the first image and the second image; and
training the object detection model based on the second position and the corresponding position.

### Supplementary Note 8

The model generation method according to Supplementary Note 7, comprising
calculating a deformation parameter for deforming the first image to the second image based on the first image and the second image, and generating the corresponding position from the first position using the deformation parameter.

### Supplementary Note 9

The model generation method according to Supplementary Note 7, comprising
training the object detection model so as to decrease an error between the second position that is the position of the object within the second image detected using the object detection model and position information based on the corresponding position.

### Supplementary Note 10

A non-transitory computer-readable storage medium storing a program, the program comprising instructions for causing a computer to execute processes to:
detect, using an object detection model, a first position that is a position of an object in a first image and a second position that is a position of an object in a second image with a different angle of view from the first image;
generate a corresponding position that is a corresponding position within the second image to the first position from the first position based on a difference in angle of view between the first image and the second image; and
train the object detection model based on the second position and the corresponding position.

### REFERENCE SIGNS LIST

2 image database
3 product shelf
4 security camera
5 mobile device camera
6 terminal device
20 object position estimating unit
30 loss calculating unit
50 geometric deformation calculating unit
51 feature point extracting unit
52 feature point coincidence degree calculating unit
53 geometric deformation parameter estimating unit
60 automatic annotating unit
61 detection result transferring unit
62 ground truth box generating unit
100 object detection apparatus
101 communicating unit
102 processor
103 memory
104 recording medium

What is claimed is:

1. A model generation apparatus comprising:
at least one memory storing processing instructions; and
at least one processor configured to execute the processing instructions to:
detect, using an object detection model, a first position that is a position of an object in a first image and a second position that is a position of an object in a second image with a different angle of view from the first image;
generate a corresponding position that is a corresponding position within the second image to the first position from the first position based on a difference in angle of view between the first image and the second image; and
train the object detection model based on the second position and the corresponding position.

2. The model generation apparatus according to claim 1, wherein the at least one processor is configured to execute the processing instructions to
calculate a deformation parameter for deforming the first image to the second image based on the first image and the second image, and generate the corresponding position from the first position using the deformation parameter.

3. The model generation apparatus according to claim 2, wherein the at least one processor is configured to execute the processing instructions to
extract a first feature point within the first image and a second feature point within the second image corresponding to the first feature point, and calculate the deformation parameter based on the first feature point and the second feature point.

4. The model generation apparatus according to claim 2, wherein the at least one processor is configured to execute the processing instructions to
deform a box region corresponding to the first position using the deformation parameter, and generate the corresponding position.

5. The model generation apparatus according to claim 1, wherein the at least one processor is configured to execute the processing instructions to
train the object detection model so as to decrease an error between the second position that is the position of the object within the second image detected using the object detection model and position information based on the corresponding position.

6. The model generation apparatus according to claim 5, wherein the at least one processor is configured to execute the processing instructions to
train the object detection model so as to decrease an error between the second position that is the position of the object within the second image detected using the object detection model and position information composed of a box including a region of the corresponding position.

7. A model generation method comprising:
detecting, using an object detection model, a first position that is a position of an object in a first image and a second position that is a position of an object in a second image with a different angle of view from the first image;
generating a corresponding position that is a corresponding position within the second image to the first position from the first position based on a difference in angle of view between the first image and the second image; and
training the object detection model based on the second position and the corresponding position.

8. The model generation method according to claim 7, comprising
calculating a deformation parameter for deforming the first image to the second image based on the first image and the second image, and generating the corresponding position from the first position using the deformation parameter.

9. The model generation method according to claim 7, comprising
training the object detection model so as to decrease an error between the second position that is the position of the object within the second image detected using the object detection model and position information based on the corresponding position.

10. A non-transitory computer-readable storage medium storing a program, the program comprising instructions for causing a computer to execute processes to:
detect, using an object detection model, a first position that is a position of an object in a first image and a second position that is a position of an object in a second image with a different angle of view from the first image;
generate a corresponding position that is a corresponding position within the second image to the first position from the first position based on a difference in angle of view between the first image and the second image; and
train the object detection model based on the second position and the corresponding position.

11. The model generation method according to claim 8, comprising
extracting a first feature point within the first image and a second feature point within the second image corresponding to the first feature point, and calculating the deformation parameter based on the first feature point and the second feature point.

12. The model generation method according to claim 8, comprising
deforming a box region corresponding to the first position using the deformation parameter, and generating the corresponding position.

13. The model generation method according to claim 9, comprising
training the object detection model so as to decrease an error between the second position that is the position of the object within the second image detected using the object detection model and position information composed of a box including a region of the corresponding position.
